(19) United States
(12) Patent Application Publication
(10) Pub. No.: US 2025/0116013 A1
(43) Pub. Date: Apr. 10, 2025

(54) CHROMIUM ALLOY CONTAINER AND METAL-SUPPORTED ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/919,515

(22) Filed: Oct. 18, 2024

Related U.S. Application Data
(63) Continuation of application No. PCT/JP2023/036371, filed on Oct. 5, 2023.

(51) Int. Cl. C25B 9/60; C22C 27/06; C25B 1/042

(52) U.S. Cl. CPC C25B 9/60; C22C 27/06; C25B 1/042

(57) ABSTRACT

A chromium alloy container includes a first alloy member constituted by an alloy containing chromium, a second alloy member constituted by an alloy containing chromium, and an adhering portion adhering the first alloy member and the second alloy member to each other. The adhering portion is constituted by an oxide containing chromium as a main component.

### CROSS-REFERENCE TO RELATED APPLICATION

This is a continuation of PCT/JP2023/036371, filed Oct. 5, 2023, the entire contents of which are hereby incorporated by reference.

### TECHNICAL FIELD

The present invention relates to a chromium alloy container and a metal-supported electrochemical cell.

### BACKGROUND ART

A chromium alloy container for housing a fuel cell is disclosed in JP 2015-156352A. The chromium alloy container includes a first interconnector, a second interconnector, a separator, an anode frame, and a glass seal.

The first interconnector is connected to an air electrode of the fuel cell. The second interconnector is connected to an anode current collecting layer of the fuel cell. The separator is connected to a solid electrolyte of the fuel cell and separates flow paths for fuel gas and oxidant gas. The anode frame is disposed between the separator and the second interconnector. The glass seal adheres the first interconnector and the separator to each other.

The first interconnector, the second interconnector, the separator, and the anode frame are each constituted by a chromium alloy (e.g., SUS430 or SUS444). The glass seal is constituted by a glass material.

### SUMMARY

In the chromium alloy container described in JP 2015-156352A, when the chromium contained in the first interconnector and the separator diffuses into the glass seal, the composition of the glass seal changes, and the strength is likely to decrease. As a result, the glass seal may deform or crack, thus making it impossible to maintain adhesion between alloy members for a long period of time. This is not limited to containers that house fuel cells, and is a common problem for chromium alloy containers in general.

An object of the present invention is to provide a chromium alloy container and a metal-supported electrochemical cell in which adhesion between alloy members can be maintained for a long period of time.

A chromium alloy container according to a first aspect of the present invention includes a first alloy member constituted by an alloy containing chromium, a second alloy member constituted by an alloy containing chromium, and an adhering portion adhering the first alloy member and the second alloy member to each other. The adhering portion is constituted by an oxide containing chromium as a main component.

A chromium alloy container according to a second aspect of the present invention is the chromium alloy container according to the first aspect, wherein a chromium content among metal elements in the oxide is 50 mol % or more.

A chromium alloy container according to a third aspect of the present invention is the chromium alloy container according to the first or second aspect, wherein the oxide is constituted by at least either chromium oxide or chromium manganese oxide.

A chromium alloy container according to a fourth aspect of the present invention is the chromium alloy container according to any of the first to third aspects, wherein the oxide is crystalline.

A chromium alloy container according to a fifth aspect of the present invention is the chromium alloy container according to the fourth aspect, wherein the oxide has a spinel type crystal structure or a corundum type crystal structure.

A chromium alloy container according to a sixth aspect of the present invention is the chromium alloy container according to any of the first to fifth aspects, wherein the adhering portion includes a first layer disposed on the first alloy member, and a second layer disposed between the first layer and the second alloy member. An oxide constituting the second layer is different from an oxide constituting the first layer.

A chromium alloy container according to a seventh aspect of the present invention is the chromium alloy container according to the sixth aspect, wherein the adhering portion further includes a third layer sandwiched between the second layer and the second alloy member. An oxide constituting the third layer corresponds to the oxide constituting the first layer.

A chromium alloy container according to an eighth aspect of the present invention is the chromium alloy container according to the seventh aspect, wherein a thickness ratio of a thickest layer to a thinnest layer among the first layer, the second layer, and the third layer is 5 or less.

A chromium alloy container according to a ninth aspect of the present invention is the chromium alloy container according to any of the sixth to eighth aspects, wherein a surface of the first alloy member includes a contact region in contact with the adhering portion, the contact region including a first region in contact with the first layer and a second region in contact with the second layer. The second region is continuous with the first region.

A chromium alloy container according to a tenth aspect of the present invention is the chromium alloy container according to the ninth aspect, wherein the adhering portion is embedded in a bottomed recess formed between the first alloy member and the second alloy member. A number of layers constituting a portion of the adhering portion exposed at an opening of the bottomed recess is greater than the number of layers constituting a portion of the adhering portion disposed in a deepest portion of the bottomed recess.

A chromium alloy container according to an eleventh aspect of the present invention is the chromium alloy container according to any of the first to tenth aspects, wherein the adhering portion is a seal for sealing the internal space.

A chromium alloy container according to a twelfth aspect of the present invention is the chromium alloy container according to any of the first to tenth aspects, wherein the second alloy member has an embossed portion in contact with the first alloy member. The adhering portion adheres the embossed portion to the first alloy member.

A metal-supported electrochemical cell according to a thirteenth aspect of the present invention includes the chromium alloy container according to any of the first to twelfth aspects, and a cell body portion disposed on the chromium alloy container. The first alloy member has a plurality of communication holes in communication with the internal space. The cell body portion is disposed on the first alloy member in such a manner as to cover the plurality of communication holes.

According to the present invention, it is possible to provide a chromium alloy container and a metal-supported electrochemical cell in which adhesion between alloy members can be maintained for a long period of time.

### BRIEF DESCRIPTION OF DRAWINGS

FIG. 1 is a plan view of an electrolysis cell according to a first embodiment.

FIG. 2 is a cross-sectional view taken along line A-A in FIG. 1.

FIG. 3 is an enlarged view of a portion of FIG. 2.

FIG. 4 is a cross-sectional view of an electrolysis cell according to a second embodiment.

FIG. 5 is an enlarged view of a portion of FIG. 4.

### DESCRIPTION OF EMBODIMENTS

### 1. First Embodiment

### (Electrolysis Cell 1)

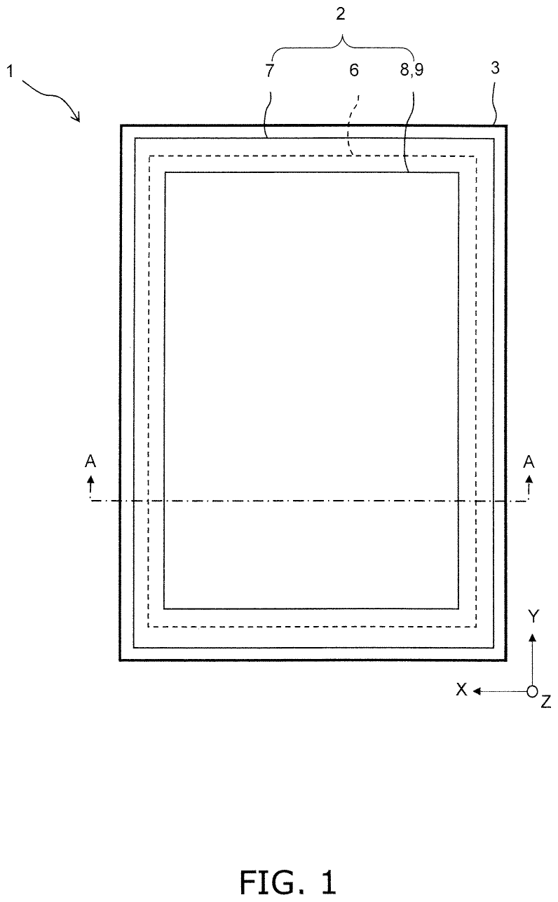

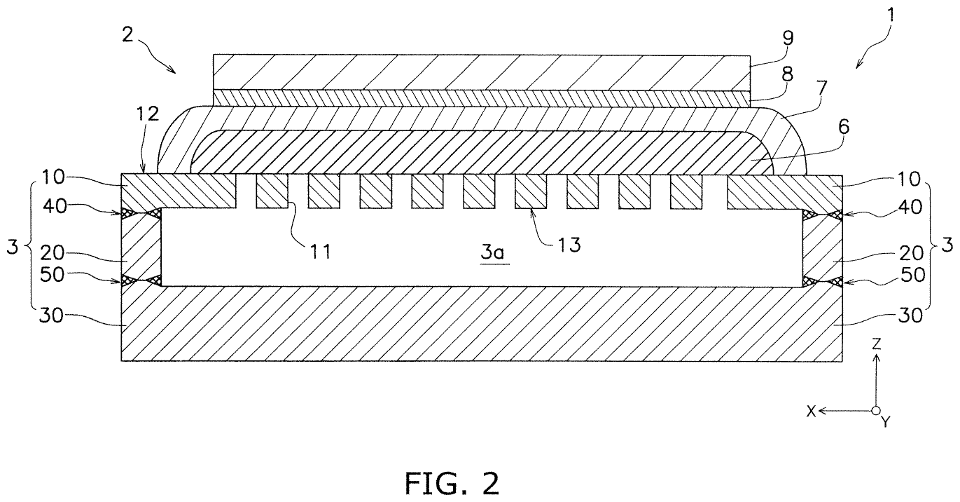

FIG. 1 is a plan view of an electrolysis cell 1 according to a first embodiment. FIG. 2 is a cross-sectional view taken along line A-A in FIG. 1.

The electrolysis cell 1 is an example of a “metal-supported electrochemical cell” according to the present invention.

The electrolysis cell 1 is shaped as a plate extending in an X-axis direction and a Y-axis direction. In the present embodiment, the electrolysis cell 1 is shaped as a rectangle extending in the Y-axis direction when viewed in a plan view from a Z-axis direction perpendicular to the X-axis direction and the Y-axis direction. However, the planar shape of the electrolysis cell 1 is not particularly limited, and may be a polygon other than a rectangle, such as an ellipse, a circle, or the like.

As shown in FIGS. 1 and 2, the electrolysis cell 1 includes a cell body portion 2 and a chromium alloy container 3.

### (Cell Body Portion 2)

The cell body portion 2 is disposed on the chromium alloy container 3. The cell body portion 2 is supported by a later-described metal support 10 of the chromium alloy container 3. The cell body portion 2 includes a hydrogen electrode 6 (cathode), an electrolyte 7, a reaction prevention layer 8, and an oxygen electrode 9 (anode).

The hydrogen electrode 6, the electrolyte 7, the reaction prevention layer 8, and the oxygen electrode 9 are stacked in this order from the chromium alloy container 3 side in the Z-axis direction. The hydrogen electrode 6, the electrolyte 7, and the oxygen electrode 9 are essential components, whereas the reaction prevention layer 8 is an optional component.

### [Hydrogen Electrode 6]

The hydrogen electrode 6 is disposed on a first main surface 12 of the metal support 10.

A raw material gas is supplied to the hydrogen electrode 6 through supply holes 11 in the metal support 10. The raw material gas contains at least water vapor (H₂O).

When the raw material gas contains only H₂O, the hydrogen electrode 6 produces H₂ from the raw material gas in accordance with water electrolysis, which is the electrochemical reaction shown in the following formula (1).

Hydrogen electrode 6: H₂O+2e⁻→H₂+O²⁻ (1)

When the raw material gas contains CO₂ in addition to H₂O, the hydrogen electrode 6 produces H₂, CO, and O²⁻ from the raw material gas in accordance with co-electrolysis, which are the co-electrochemical reactions shown in the following formulas (2), (3), and (4).

Hydrogen electrode 6: CO₂+H₂O+4e⁻→CO+H₂+2O²⁻ (2)

H₂O electrochemical reaction: H₂O+2e⁻→H₂+O²⁻ (3)

CO₂ electrochemical reaction: CO₂+2e⁻→CO+O²⁻ (4)

H₂ produced in the hydrogen electrode 6 flows out from the supply holes 11 of the metal support 10 into a later-described internal space 3a.

The hydrogen electrode 6 is a porous body that has electronic conductivity. The hydrogen electrode 6 contains nickel (Ni). In the case of co-electrolysis, Ni functions as an electronic conductor, and also functions as a thermal catalyst that promotes the thermal reaction between the produced H₂ and the CO₂ contained in the raw material gas to maintain an appropriate gas composition for methanation, Fischer-Tropsch (FT) synthesis, and the like. The Ni contained in the hydrogen electrode 6 is essentially present in the form of metal Ni during operation of the electrolysis cell 1, but may also partially be present in the form of nickel oxide (NiO).

The hydrogen electrode 6 may contain an ion conductive material. Examples of the ion conductive material that can be used include yttria-stabilized zirconia (YSZ), calcia-stabilized zirconia (CSZ), scandia-stabilized zirconia (ScSZ), gadolinium-doped ceria (GDC), samarium-doped ceria (SDC), (La,Sr)(Cr,Mn)O₃, (La,Sr)TiO₃, Sr₂(Fe,Mo)₂O₆, (La,Sr)VO₃, (La,Sr)FeO₃, and mixed materials containing two or more of these.

The thickness of the hydrogen electrode 6 is not particularly limited, but can be, for example, 1 μm or more and 100 μm or less. The value of the thermal expansion coefficient of the hydrogen electrode 6 is not particularly limited, but can be, for example, 12×10⁻⁶/° C. or more and 20×10⁻⁶/° C. or less.

The method for forming the hydrogen electrode 6 is not particularly limited, and may be a firing method, a spray coating method (such as a thermal spray method, an aerosol deposition method, an aerosol gas deposition method, a powder jet deposition method, a particle jet deposition method, or a cold spray method), a PVD method (such as a sputtering method or a pulsed laser deposition method), or a CVD method, for example.

### [Electrolyte 7]

The electrolyte 7 is formed on the hydrogen electrode 6. The electrolyte 7 is disposed between the hydrogen electrode 6 and the oxygen electrode 9. In the present embodiment, the electrolyte 7 is sandwiched between the hydrogen electrode 6 and the reaction prevention layer 8 and is connected to both of them.

The electrolyte 7 covers the hydrogen electrode 6 and also covers the region of the first main surface 12 of the metal support 10 that is exposed from the hydrogen electrode 6.

The electrolyte 7 is a dense body that has oxide ion conductivity. The electrolyte 7 transfers O²⁻ produced at the hydrogen electrode 6 toward the oxygen electrode 9. The electrolyte 7 is constituted by an oxide ion conductive material. The electrolyte 7 can be constituted by, for example, YSZ, GDC, ScSZ, SDC, LSGM (lanthanum gallate), or the like, with YSZ being particularly preferable.

The thickness of the electrolyte 7 is not particularly limited, but can be, for example, 1 μm or more and 100 μm or less. The value of the thermal expansion coefficient of the electrolyte 7 is not particularly limited, but can be, for example, 10×10⁻⁶/° C. or more and 12×10⁻⁶/° C. or less.

The method for forming the electrolyte 7 is not particularly limited, and a firing method, a spray coating method, a PVD method, a CVD method, or the like can be used.

### [Reaction Prevention Layer 8]

The reaction prevention layer 8 is disposed between the electrolyte 7 and the oxygen electrode 9. The reaction prevention layer 8 is disposed on the side of the electrolyte 7 opposite to the hydrogen electrode 6 side. The reaction prevention layer 8 suppresses the formation of a layer with high electrical resistance caused by constituent elements of the electrolyte 7 reacting with constituent elements of the oxygen electrode 9.

The reaction prevention layer 8 is constituted by an oxide ion conductive material. The reaction prevention layer 8 can be constituted by GDC, SDC, or the like.

The porosity of the reaction prevention layer 8 is not particularly limited, but can be, for example, 0.1% or more and 50% or less. The thickness of the reaction prevention layer 8 is not particularly limited, but may be, for example, 1 μm or more and 50 μm or less.

The method for forming the reaction prevention layer 8 is not particularly limited, and a firing method, a spray coating method, a PVD method, a CVD method, or the like can be used.

### [Oxygen Electrode 9]

The oxygen electrode 9 is disposed on the side of the electrolyte 7 opposite to the hydrogen electrode 6 side. In the present embodiment, the reaction prevention layer 8 is disposed between the electrolyte 7 and the oxygen electrode 9, and therefore the oxygen electrode 9 is connected to the reaction prevention layer 8. When the reaction prevention layer 8 is not disposed between the electrolyte 7 and the oxygen electrode 9, the oxygen electrode 9 is connected to the electrolyte 7.

The oxygen electrode 9 produces O₂ from O²⁻ transferred from the hydrogen electrode 6 via the electrolyte 7 in accordance with the chemical reaction of the following formula (5).

Oxygen electrode 9: 2O²⁻→O₂+4e⁻ (5)

The oxygen electrode 9 is a porous body that has oxide ion conductivity and electronic conductivity. The oxygen electrode 9 can be formed of a composite material containing an oxide ion conductive material (such as GDC) and one or more of (La,Sr)(Co,Fe)O₃, (La,Sr)FeO₃, La(Ni,Fe)O₃, (La,Sr)CoO₃, and (Sm,Sr)CoO₃.

The porosity of the oxygen electrode 9 is not particularly limited, but can be, for example, 20% or more and 60% or less. The thickness of the oxygen electrode 9 is not particularly limited, but can be, for example, 1 μm or more and 100 μm or less.

The method for forming the oxygen electrode 9 is not particularly limited, and a firing method, a spray coating method, a PVD method, a CVD method, or the like can be used.

### (Chromium Alloy Container 3)

The chromium alloy container 3 includes the internal space 3a through which the raw material gas supplied to the hydrogen electrode 6 and the reducing gas (H₂ in the present embodiment) produced in the hydrogen electrode 6 flow.

In the present embodiment, the chromium alloy container 3 includes the metal support 10, a frame 20, an interconnector 30, a first sealing portion 40, and a second sealing portion 50. The internal space 3a is a space surrounded by the metal support 10, the frame 20, the interconnector 30, the first sealing portion 40, and the second sealing portion 50.

In the present embodiment, either the metal support 10 or the frame 20 is an example of the “first alloy member” according to the present invention, and the other one is an example of the “second alloy member” according to the present invention. Also, in the present embodiment, either the frame 20 or the interconnector 30 is an example of the “first alloy member” according to the present invention, and the other one is an example of the “second alloy member” according to the present invention.

### [Metal Support 10]

The metal support 10 supports the cell body portion 2. In the present embodiment, the metal support 10 is formed in a plate shape. The metal support 10 may be shaped as a flat plate or a curved plate.

The metal support 10 is only required to be able to support the cell body portion 2, and the thickness is not particularly limited, but can be, for example, 0.1 mm or more and 2.0 mm or less.

As shown in FIG. 2, the metal support 10 includes the supply holes 11, the first main surface 12, and the second main surface 13.

The supply holes 11 pass through the metal support 10 from the first main surface 12 to the second main surface 13. The supply holes 11 are open at both the first main surface 12 and the second main surface 13. The supply holes 11 are covered by the cell body portion 2. Specifically, the openings of the supply holes 11 on the first main surface 12 side are covered by the hydrogen electrode 6. The openings of the supply holes 11 on the second main surface 13 side are in communication with the internal space 3a.

The supply holes 11 can be formed by mechanical processing (e.g., punching), laser processing, chemical processing (e.g., etching), or the like.

In the present embodiment, the supply holes 11 extend straight along the Z-axis direction. However, the supply holes 11 may be inclined with respect to the Z-axis direction, and do not need to be linear. Moreover, the supply holes 11 may be connected to each other.

The first main surface 12 is provided on the side opposite to the second main surface 13. The cell body portion 2 is disposed on the first main surface 12. The frame 20 is joined to the second main surface 13 via the first sealing portion 40.

The metal support 10 is constituted by an alloy containing Cr (chromium). Examples of such alloys include Fe—Cr alloy steel (such as stainless steel) and Ni—Cr alloy steel. The Cr content in the metal support 10 is not particularly limited, but can be set to 4 mass % or more and 30 mass % or less.

The metal support 10 may contain Ti (titanium) and/or Zr (zirconium). The Ti content in the metal support 10 is not particularly limited, but can be set to 0.01 mol % or more and 1.0 mol % or less. The Zr content in the metal support 10 is not particularly limited, but can be set to 0.01 mol % or more and 0.4 mol % or less. The metal support 10 may contain Ti as TiO₂ (titania) and Zr as ZrO₂ (zirconia).

### [Frame 20]

The frame 20 is a spacer for forming the internal space 3a. In the present embodiment, the frame 20 is formed in an annular shape.

The frame 20 is joined to the metal support 10 via the first sealing portion 40, and is joined to the interconnector 30 via the second sealing portion 50.

The thickness of the frame 20 is not particularly limited, but may be, for example, 0.1 mm or more and 2.0 mm or less.

The frame 20 is constituted by an alloy containing Cr. Examples of such alloys include Fe—Cr alloy steel and Ni—Cr alloy steel. The Cr content in the frame 20 is not particularly limited, but can be set to 4 mass % or more and 30 mass % or less. The composition of the frame 20 may be the same as or different from that of the metal support 10.

### [Interconnector 30]

The interconnector 30 is disposed on the side of the frame 20 opposite to the metal support 10 side. The interconnector 30 is a member for electrically connecting the electrolysis cell 1 to an external power source or another electrolysis cell.

In the present embodiment, the interconnector 30 is formed in a plate shape. The interconnector 30 may be shaped as a flat plate or a curved plate.

The interconnector 30 is joined to the frame 20 via the second sealing portion 50.

The thickness of the interconnector 30 is not particularly limited, but can be, for example, 0.1 mm or more and 2.0 mm or less.

The interconnector 30 is constituted by an alloy containing Cr. Examples of such alloys include Fe—Cr alloy steel and Ni—Cr alloy steel. The Cr content in the interconnector 30 is not particularly limited, but can be set to 4 mass % or more and 30 mass % or less. The composition of the interconnector 30 may be the same as or different from that of the metal support 10. The composition of the interconnector 30 may be the same as or different from that of the frame 20.

### [First Sealing Portion 40]

The first sealing portion 40 is disposed between the metal support 10 and the frame 20. The first sealing portion 40 is joined to both the metal support 10 and the frame 20.

The first sealing portion 40 seals the gap between the metal support 10 and the frame 20. This prevents the raw material gas supplied to the hydrogen electrode 6 and the reducing gas produced in the hydrogen electrode 6 from leaking to the outside through the gap between the metal support 10 and the frame 20. The detailed configuration of the first sealing portion 40 will be described later.

### [Second Sealing Portion 50]

The second sealing portion 50 is disposed between the frame 20 and the interconnector 30. The second sealing portion 50 is joined to both the frame 20 and the interconnector 30.

The second sealing portion 50 seals the gap between the frame 20 and the interconnector 30. This prevents the raw material gas supplied to the hydrogen electrode 6 and the reducing gas produced in the hydrogen electrode 6 from leaking to the outside through the gap between the frame 20 and the interconnector 30.

The configuration of the second sealing portion 50 is the same as the configuration of the first sealing portion 40, which will be described next, and therefore, in the present embodiment, a description will not be given for the configuration of the second sealing portion 50.

### (Detailed Configuration of First Sealing Portion 40)

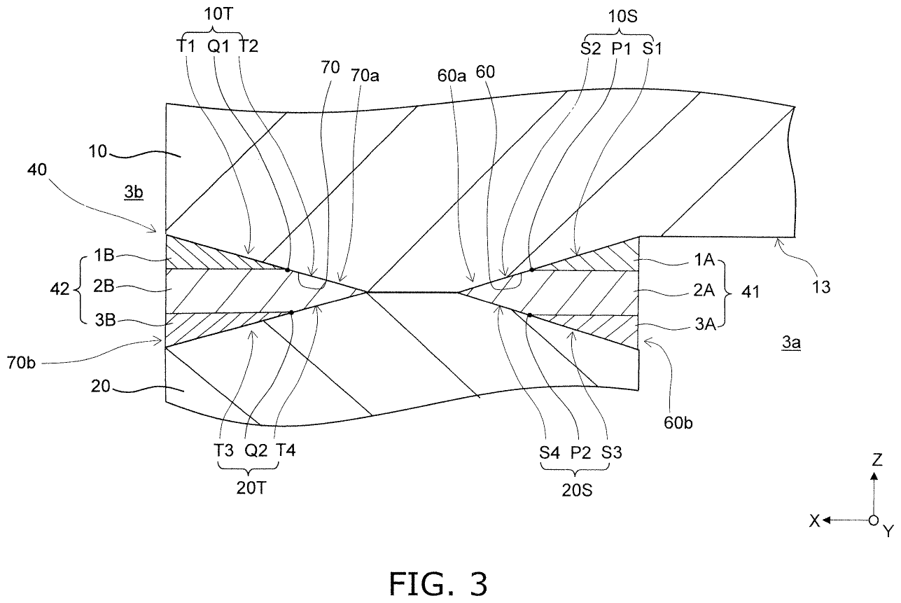

FIG. 3 is an enlarged view of a portion of FIG. 2. A cross section of the first sealing portion 40 is shown in FIG. 3. The cross section illustrated in FIG. 3 is perpendicular to the second main surface 13 of the metal support 10.

The first sealing portion 40 includes a first adhering portion 41 and a second adhering portion 42. The first adhering portion 41 and the second adhering portion 42 are each an example of the “adhering portion” according to the present invention.

### [First Adhering Portion 41]

The first adhering portion 41 is disposed between the metal support 10 and the frame 20. The first adhering portion 41 is sandwiched between the metal support 10 and the frame 20. The first adhering portion 41 is formed in an annular shape so as to surround the internal space 3a. The first adhering portion 41 functions as a seal for sealing the internal space 3a.

In the present embodiment, the first adhering portion 41 is embedded in a bottomed recess 60 formed between the metal support 10 and the frame 20. The cross section of the bottomed recess 60 is wedge-shaped. The bottomed recess 60 has a deepest portion 60a and an opening 60b. The opening 60b is open toward the internal space 3a. The first adhering portion 41 is exposed to the internal space 3a.

The first adhering portion 41 is constituted by an oxide containing Cr as a main component (hereinafter, abbreviated as “Cr oxide”). This makes it possible to suppress the diffusion of Cr from the metal support 10 and the frame 20 to the first adhering portion 41 during the manufacture and operation of the electrolysis cell 1. Furthermore, even if Cr diffuses from the metal support 10 and the frame 20 to the first adhering portion 41, the effect on the composition of the first adhering portion 41 is small, thus making it possible to suppress a decrease in the strength of the first adhering portion 41. Furthermore, since the metal support 10, the frame 20, and the first adhering portion 41 all contain Cr, the adhesion therebetween can be improved. Therefore, the adhesion between the metal support 10 and the frame 20 can be maintained for a long period of time.

In the present embodiment, the term “containing Cr as a main component” means that when the composition of the Cr oxide constituting the first adhering portion 41 is analyzed using an energy dispersive spectroscopy (EDS) device, the Cr content is the highest among the metal elements in the Cr oxide. The Cr content is not particularly limited, but can be, for example, 20 mol % or more and 100 mol % or less.

It is preferable that the Cr content among the metal elements in the Cr oxide constituting the first adhering portion 41 is 50 mol % or more. This makes it possible to significantly suppress the diffusion of Cr contained in the metal support 10 and the frame 20 to the first adhering portion 41.

It is preferable that the Cr oxide constituting the first adhering portion 41 is constituted by at least either chromium oxide or chromium manganese oxide. A property of these oxides is particularly suppressing the diffusion of Cr, and therefore the durability of the first adhering portion 41 can be improved.

One example of a chromium oxide is Cr₂O₃. Examples of chromium manganese oxides include MnCr₂O₄ (spinel) and Mn_{1,5}Cr_{1,5}O₄ (spinel).

It is preferable that the Cr oxide constituting the first adhering portion 41 is crystalline. Accordingly, even when the electrolysis cell 1 is operated for a long period, it is possible to avoid the case where the first adhering portion 41 becomes damaged due to a phase transition of the Cr oxide from amorphous to crystalline. first adhering portion 41 has a spinel type or a corundum type crystal structure. These crystal structures are highly symmetrical, and therefore the thermal stress resistance of the first adhering portion 41 can be improved.

Here, as shown in FIG. 3, the first adhering portion 41 according to the present embodiment is constituted by a first layer 1A, a second layer 2A, and a third layer 3A.

The first layer 1A is disposed on the metal support 10. The first layer 1A is sandwiched between the metal support 10 and the second layer 2A. In the present embodiment, the first layer 1A is constituted by Cr₂O₃.

The second layer 2A is disposed between the first layer 1A and the frame 20. In the present embodiment, due to the first adhering portion 41 including the third layer 3A, the second layer 2A is sandwiched between the first layer 1A and the third layer 3A. A portion of the second layer 2A fills the deepest portion 60a of the bottomed recess 60. The portion of the second layer 2A that fills the deepest portion 60a is sandwiched between the metal support 10 and the frame 20.

It is preferable that the oxide that constitutes the second layer 2A is different from the oxide that constitutes the first layer 1A. Accordingly, a crack that attempts to propagate in the Z-axis direction from the first layer 1A toward the second layer 2A, or from the second layer 2A toward the first layer 1A, can be stopped at the interface between the first layer 1A and the second layer 2A. In the present embodiment, the second layer 2A is constituted by chromium manganese oxide.

The third layer 3A is disposed on the frame 20. The third layer 3A is sandwiched between the second layer 2A and the frame 20. It is preferable that the oxide that constitutes the third layer 3A is different from the oxide that constitutes the second layer 2A. Accordingly, a crack that attempts to propagate in the Z-axis direction from the second layer 2A toward the third layer 3A, or from the third layer 3A toward the second layer 2A, can be stopped at the interface between the second layer 2A and the third layer 3A. In the present embodiment, the third layer 3A is constituted by Cr₂O₃.

It is preferable that the oxide that constitutes the third layer 3A is the same as the oxide that constitutes the first layer 1A. Accordingly, the first adhering portion 41 has a symmetrical structure in the thickness direction parallel to the Z-axis direction, and therefore the mechanical reliability of the first adhering portion 41 can be improved.

The thickness of the first layer 1A is not particularly limited, but can be, for example, 0.1 μm or more and 100 μm or less. The thickness of the second layer 2A is not particularly limited, but can be, for example, 0.1 μm or more and 100 μm or less. The thickness of the third layer 3A is not particularly limited, but may be, for example, 0.1 μm or more and 100 μm or less. The thickness of the first layer 1A is obtained by obtaining the arithmetic average of thicknesses measured at three locations that divide the first layer 1A into four equal parts in the planar direction perpendicular to the Z-axis direction. The thicknesses of the second layer 2A and the third layer 3A are each obtained similarly to the thickness of the first layer 1A.

It is preferable that the thickness ratio of the thickest layer to the thinnest layer among the first layer 1A, the second layer 2A, and the third layer 3A is 5 or less. By reducing variation in the thicknesses of the layers in this manner, it is possible to improve the mechanical reliability of the first adhering portion 41.

As shown in FIG. 3, the metal support 10 includes a contact region 10S that is in contact with the first adhering portion 41. In the present embodiment, the contact region 10S is a part of the second main surface 13. It is preferable that the contact region 10S includes a first region S1 in contact with the first layer 1A, and a second region S2 that is continuous with the first region S1 at a connection point P1 and in contact with the second layer 2A. Accordingly, a crack propagating inward from a position between the first layer 1A and the second layer 2A (i.e., away from the internal space 3a) can be stopped at the connection point P1.

As shown in FIG. 3, the frame 20 includes a contact region 20S that is in contact with the first adhering portion 41. It is preferable that the contact region 20S includes a third region S3 in contact with the third layer 3A, and a fourth region S4 that is continuous with the third region S3 at a connection point P2 and in contact with the second layer 2A. Accordingly, a crack propagating inward from a position between the second layer 2A and the third layer 3A can be stopped at the connection point P2.

Furthermore, it is preferable that, as shown in FIG. 3, the number of layers constituting the portion of the first adhering portion 41 exposed at the opening 60b of the bottomed recess 60 is greater than the number of layers constituting the portion of the first adhering portion 41 disposed in the deepest portion 60a of the bottomed recess 60. As a result, the number of layer interfaces is smaller on the deepest portion 60a side than on the opening 60b side. Therefore, it is possible to suppress the case where a crack attempting to propagate inward along a layer interface reaches the deepest portion 60a. Note that in the present embodiment, the number of layers constituting the portion of the first adhering portion 41 exposed at the opening 60b is “3”, and the number of layers constituting the portion of the first adhering portion 41 disposed in the deepest portion 60a is “1”.

The first adhering portion 41 can be formed by applying a paste containing Cr oxide to the surface of at least either the metal support 10 or the frame 20, and then performing a heat treatment while the metal support 10 and the frame 20 are held in close contact with each other. The heat treatment conditions can be appropriately set, for example, at 600° C. or higher and 1100° C. or lower, and for 0.5 hours or more and 24 hours or less.

### [Second Adhering Portion 42]

The second adhering portion 42 is disposed between the metal support 10 and the frame 20. The second adhering portion 42 is sandwiched between the metal support 10 and the frame 20. The second adhering portion 42 is disposed on the side of the first adhering portion 41 opposite to the internal space 3a side. The second adhering portion 42 is formed in an annular shape so as to surround the first adhering portion 41. The second adhering portion 42 functions as a seal for sealing the internal space 3a.

The second adhering portion 42 is spaced apart from the first adhering portion 41 in the planar direction. In the region between the first adhering portion 41 and the second adhering portion 42, the metal support 10 and the frame 20 are in close contact with each other or are integrated with each other. It is preferable that the metal support 10 and the frame 20 are integrated together by welding or brazing in order to improve the electrical connection therebetween.

In the present embodiment, the second adhering portion 42 is embedded in a bottomed recess 70 formed between the metal support 10 and the frame 20. The cross section of the bottomed recess 70 is wedge-shaped. The bottomed recess 70 has a deepest portion 70a and an opening 70b. The opening 70b is open toward an external space 3b. The second adhering portion 42 is exposed to the external space 3b.

The second adhering portion 42 is constituted by Cr oxide. This makes it possible to suppress the diffusion of Cr from the metal support 10 and the frame 20 to the second adhering portion 42 during the manufacture and operation of the electrolysis cell 1. Furthermore, even if Cr diffuses from the metal support 10 and the frame 20 to the second adhering portion 42, the effect on the composition of the second adhering portion 42 is small, thus making it possible to suppress a decrease in the strength of the second adhering portion 42. Furthermore, since the metal support 10, the frame 20, and the second adhering portion 42 all contain Cr, the adhesion therebetween can be improved. Therefore, the adhesion between the metal support 10 and the frame 20 can be maintained for a long period of time.

The Cr content among the metal elements in the Cr oxide constituting the second adhering portion 42 can be, for example, 20 mol % or more and 100 mol % or less. It is preferable that the Cr content is 50 mol % or more. This makes it possible to significantly suppress the diffusion of Cr contained in the metal support 10 and the frame 20 to the second adhering portion 42. second adhering portion 42 is constituted by at least either chromium oxide or chromium manganese oxide. A property of these oxides is that the diffusion of Cr is particularly unlikely to occur, and therefore the durability of the second adhering portion 42 can be improved.

It is preferable that the Cr oxide constituting the second adhering portion 42 is crystalline. Accordingly, even when the electrolysis cell 1 is operated for a long period, it is possible to avoid the case where the second adhering portion 42 becomes damaged due to a phase transition of the Cr oxide from amorphous to crystalline.

It is preferable that the Cr oxide constituting the second adhering portion 42 has a spinel type or corundum type crystal structure. These crystal structures are highly symmetrical, thus making it possible to improve the thermal stress resistance of the second adhering portion 42.

Here, as shown in FIG. 3, the second adhering portion 42 according to the present embodiment is constituted by a first layer 1B, a second layer 2B, and a third layer 3B.

The first layer 1B is disposed on the metal support 10. The first layer 1B is sandwiched between the metal support 10 and the second layer 2B. In the present embodiment, the first layer 1B is constituted by Cr₂O₃.

The second layer 2B is disposed between the first layer 1B and the frame 20. In the present embodiment, due to the second adhering portion 42 including the third layer 3B, the second layer 2B is sandwiched between the first layer 1B and the third layer 3B. A portion of the second layer 2B fills the deepest portion 70a of the bottomed recess 70. The portion of the second layer 2B that fills the deepest portion 70a is sandwiched between the metal support 10 and the frame 20.

It is preferable that the oxide that constitutes the second layer 2B is different from the oxide that constitutes the first layer 1B. Accordingly, a crack that attempts to propagate in the Z-axis direction from the first layer 1B toward the second layer 2B, or from the second layer 2B toward the first layer 1B, can be stopped at the interface between the first layer 1B and the second layer 2B. In the present embodiment, the second layer 2B is constituted by chromium manganese oxide.

The third layer 3B is disposed on the frame 20. The third layer 3B is disposed between the second layer 2B and the frame 20. It is preferable that the oxide that constitutes the third layer 3B is different from the oxide that constitutes the second layer 2B. Accordingly, a crack that attempts to propagate in the Z-axis direction from the second layer 2B toward the third layer 3B, or from the third layer 3B toward the second layer 2B, can be stopped at the interface between the second layer 2B and the third layer 3B. In the present embodiment, the third layer 3B is constituted by Cr₂O₃.

It is preferable that the oxide that constitutes the third layer 3B is the same as the oxide that constitutes the first layer 1B. Accordingly, the second adhering portion 42 has a symmetrical structure in the thickness direction parallel to the Z-axis direction, and therefore the mechanical reliability of the second adhering portion 42 can be improved.

The thickness of the first layer 1B is not particularly limited, but can be, for example, 0.1 μm or more and 100 μm or less. The thickness of the second layer 2B is not particularly limited, but can be, for example, 0.1 μm or more and 100 μm or less. The thickness of the third layer 3B is not particularly limited, but can be, for example, 0.1 μm or more and 100 μm or less. The thickness of the first layer 1B is obtained by obtaining the arithmetic average of thicknesses measured at three locations that divide the first layer 1B into four equal parts in the planar direction perpendicular to the Z-axis direction. The thicknesses of the second layer 2B and the third layer 3B are each obtained similarly to the thickness of the first layer 1B.

It is preferable that the thickness ratio of the thickest layer to the thinnest layer among the first layer 1B, the second layer 2B, and the third layer 3B is 5 or less. By reducing variation in the thicknesses of the layers in this manner, it is possible to improve the mechanical reliability of the second adhering portion 42.

As shown in FIG. 3, the metal support 10 includes a contact region 10T that is in contact with the second adhering portion 42. In the present embodiment, the contact region 10T is a part of the second main surface 13. It is preferable that the contact region 10T includes a first region T1 in contact with the first layer 1B, and a second region T2 that is continuous with the first region T1 at a connection point Q1 and in contact with the second layer 2B. Accordingly, a crack propagating inward from a position between the first layer 1B and the second layer 2B (i.e., away from the external space 3b) can be stopped at the connection point Q1.

As shown in FIG. 3, the frame 20 includes a contact region 20T that is in contact with the second adhering portion 42. It is preferable that the contact region 20T includes a third region T3 in contact with the third layer 3B, and a fourth region T4 that is continuous with the third region T3 at a connection point Q2 and in contact with the second layer 2B. Accordingly, a crack propagating inward from a position between the second layer 2B and the third layer 3B can be stopped at the connection point Q2.

Furthermore, it is preferable that, as shown in FIG. 3, the number of layers constituting the portion of the second adhering portion 42 exposed at the opening 70b of the bottomed recess 70 is greater than the number of layers constituting the portion of the second adhering portion 42 disposed in the deepest portion 70a of the bottomed recess 70. As a result, the number of layer interfaces is smaller on the deepest portion 70a side than on the opening 70b side. Therefore, it is possible to suppress the case where a crack attempting to propagate inward along a layer interface reaches the deepest portion 70a. Note that in the present embodiment, the number of layers constituting the portion of the second adhering portion 42 exposed at the opening 70b is “3”, and the number of layers constituting the portion of the second adhering portion 42 disposed in the deepest portion 70a is “1”.

The second adhering portion 42 can be formed by applying a paste containing Cr oxide to the surface of at least either the metal support 10 or the frame 20, and then performing a heat treatment while the metal support 10 and the frame 20 are held in close contact with each other. The heat treatment conditions can be appropriately set, for example, at 600° C. or higher and 1100° C. or lower, and for 0.5 hours or more and 24 hours or less. Note that the second adhering portion 42 may be formed at the same time as the first adhering portion 41.

### 2. Second Embodiment

### (Electrolysis Cell 1)

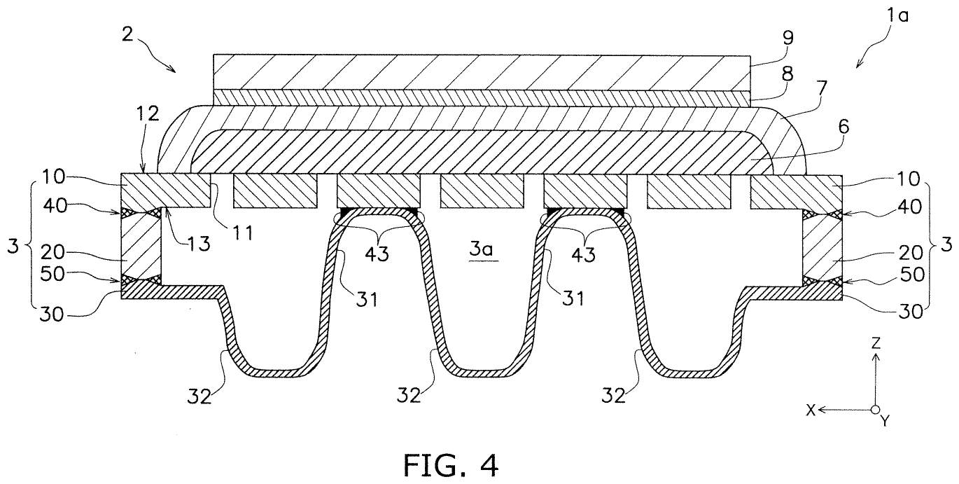

FIG. 4 is a cross-sectional view of an electrolysis cell 1a according to a second embodiment. The electrolysis cell 1a is an example of a “metal-supported electrochemical cell” according to the present invention.

The electrolysis cell 1a of the second embodiment differs from the electrolysis cell 1 of the first embodiment in that the interconnector 30 includes embossed portions 31 and debossed portions 32, and in that the chromium alloy container 3 includes third adhering portions 43. The following mainly describes the differences.

In the present embodiment, either the metal support 10 or the interconnector 30 is an example of a “first alloy member” according to the present invention, and the other one is an example of a “second alloy member” according to the present invention. The third adhering portions 43 are an example of an “adhering portion” according to the present invention.

As shown in FIG. 4, the interconnector 30 includes a plurality of embossed portions 31 and a plurality of debossed portions 32. In FIG. 4, two embossed portions 31 and three debossed portions 32 are shown, but the number of embossed portions 31 and the number of debossed portions 32 can be changed as appropriate.

The embossed portions 31 are in contact with the second main surface 13 of the metal support 10. As a result, the metal support 10 is supported by the interconnector 30, thus suppressing bending of the metal support 10. The embossed portions 31 only need to be in contact with the metal support 10 and do not need to be bonded to the metal support 10.

The debossed portions 32 protrude toward the side opposite to the metal support 10. The debossed portions 32 come into contact with an external power source or another electrolysis cell.

The third adhering portions 43 adhere the embossed portions 31 to the metal support 10. The third adhering portions 43 are disposed in the vicinity of the leading end portions of the embossed portions 31. The leading end portion of the embossed portion 31 refers to the portion of the embossed portion 31 that comes into contact with the metal support 10. It is preferable that the third adhering portions 43 are formed in an annular shape so as to surround the leading end portions of the embossed portions 31. This makes it possible to improve the adhesion between the embossed portions 31 and the metal support 10.

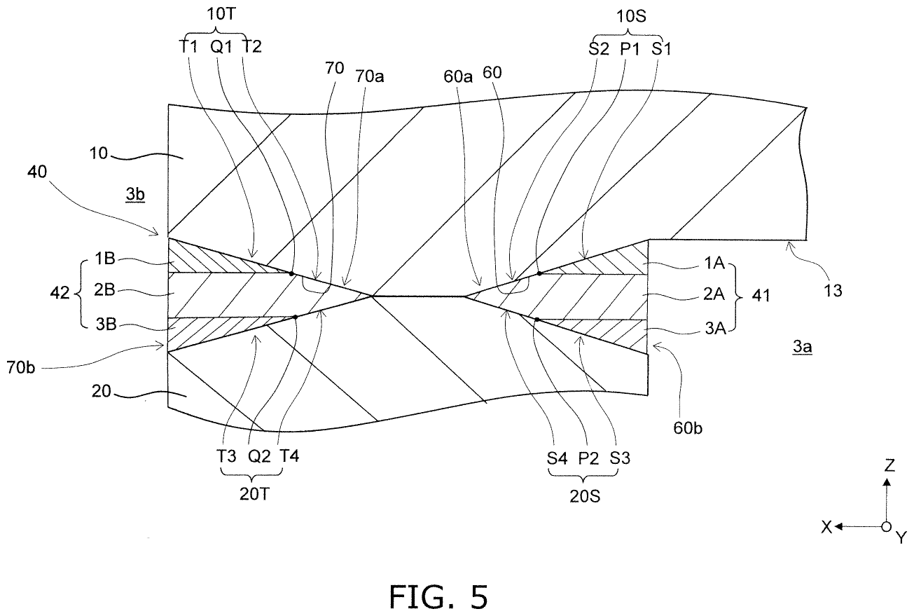

Here, FIG. 5 is an enlarged view of a portion of FIG. 4. A cross section of one third adhering portion 43 is shown in FIG. 5. The cross section illustrated in FIG. 5 is perpendicular to the second main surface 13 of the metal support 10.

The third adhering portion 43 is disposed between the metal support 10 and the embossed portion 31. The third adhering portion 43 is sandwiched between the metal support 10 and the embossed portion 31. The third adhering portion 43 is disposed on the metal support 10 and is formed in an annular shape so as to surround the leading end portion of the embossed portion 31.

In the present embodiment, the third adhering portion 43 is embedded in a bottomed recess 80 formed between the metal support 10 and the embossed portion 31. The cross section of the bottomed recess 80 is wedge-shaped. The bottomed recess 80 has a deepest portion 80a and an opening 80b. The opening 80b is open toward the internal space 3a. The third adhering portion 43 is exposed to the internal space 3a.

The third adhering portion 43 is constituted by Cr oxide. This makes it possible to suppress the diffusion of Cr from the metal support 10 and the embossed portion 31 to the third adhering portion 43 during the manufacture and operation of the electrolysis cell 1a. Furthermore, even if Cr diffuses from the metal support 10 and the embossed portion 31 to the third adhering portion 43, the effect on the composition of the third adhering portion 43 is small, thus making it possible to suppress a decrease in the strength of the third adhering portion 43. Furthermore, since the metal support 10, the embossed portion 31, and the third adhering portion 43 all contain Cr, the adhesion therebetween can be improved.

Therefore, the adhesion between the metal support 10 and the embossed portion 31 can be maintained for a long period of time.

The Cr content among the metal elements in the Cr oxide constituting the third adhering portion 43 can be, for example, 20 mol % or more and 100 mol % or less. It is preferable that the Cr content is 50 mol % or more. This makes it possible to significantly suppress the diffusion of Cr contained in the metal support 10 and the embossed portion 31 to the third adhering portion 43.

It is preferable that the Cr oxide constituting the third adhering portion 43 is constituted by at least either chromium oxide or chromium manganese oxide. A property of these oxides is that the diffusion of Cr is particularly unlikely to occur, and therefore the durability of the third adhering portion 43 can be improved.

It is preferable that the Cr oxide constituting the third adhering portion 43 is crystalline. Accordingly, even when the electrolysis cell 1a is operated for a long period, it is possible to avoid the case where the third adhering portion 43 becomes damaged due to a phase transition of the Cr oxide from amorphous to crystalline. third adhering portion 43 has a spinel type or corundum type crystal structure. These crystal structures are highly symmetrical, thus making it possible to improve the thermal stress resistance of the third adhering portion 43.

Here, as shown in FIG. 5, the third adhering portion 43 according to the present embodiment is constituted by a first layer 1C, a second layer 2C, and a third layer 3C.

The first layer 1C is disposed on the metal support 10. The first layer 1C is sandwiched between the metal support 10 and the second layer 2C. In the present embodiment, the first layer 1C is constituted by Cr₂O₃.

The second layer 2C is disposed between the first layer 1C and the embossed portion 31. In the present embodiment, due to the third adhering portion 43 including the third layer 3C, the second layer 2C is sandwiched between the first layer 1C and the third layer 3C. A portion of the second layer 2C fills the deepest portion 80a of the bottomed recess 80. The portion of the second layer 2C that fills the deepest portion 80a is sandwiched between the metal support 10 and the embossed portion 31.

It is preferable that the oxide that constitutes the second layer 2C is different from the oxide that constitutes the first layer 1C. Accordingly, a crack that attempts to propagate in the Z-axis direction from the first layer 1C toward the second layer 2C, or from the second layer 2C toward the first layer 1C, can be stopped at the interface between the first layer 1C and the second layer 2C. In the present embodiment, the second layer 2C is constituted by chromium manganese oxide.

The third layer 3C is disposed on the embossed portion 31. The third layer 3C is sandwiched between the second layer 2C and the embossed portion 31. It is preferable that the oxide that constitutes the third layer 3C is different from the oxide that constitutes the second layer 2C. Accordingly, a crack that attempts to propagate in the Z-axis direction from the second layer 2C toward the third layer 3C, or from the third layer 3C toward the second layer 2C, can be stopped at the interface between the second layer 2C and the third layer 3C. In the present embodiment, the third layer 3C is constituted by Cr₂O₃.

It is preferable that the oxide that constitutes the third layer 3C is the same as the oxide that constitutes the first layer 1C. Accordingly, the third adhering portion 43 has a symmetrical structure in the thickness direction parallel to the Z-axis direction, and therefore the mechanical reliability of the third adhering portion 43 can be improved.

The thickness of the first layer 1C is not particularly limited, but can be, for example, 0.1 μm or more and 100 μm or less. The thickness of the second layer 2C is not particularly limited, but can be, for example, 0.1 μm or more and 100 μm or less. The thickness of the third layer 3C is not particularly limited, but can be, for example, 0.1 μm or more and 100 μm or less. The thickness of the first layer 1C is obtained by obtaining the arithmetic average of thicknesses measured at three locations that divide the first layer 1C into four equal parts in the planar direction perpendicular to the Z-axis direction. The thicknesses of the second layer 2C and the third layer 3C are each obtained similarly to the thickness of the first layer 1C.

It is preferable that the thickness ratio of the thickest layer to the thinnest layer among the first layer 1C, the second layer 2C, and the third layer 3C is 5 or less. By reducing variation in the thicknesses of the layers in this manner, it is possible to improve the mechanical reliability of the third adhering portion 43.

As shown in FIG. 5, the metal support 10 includes a contact region 10W that is in contact with the third adhering portion 43. In the present embodiment, the contact region 10W is a part of the second main surface 13. It is preferable that the contact region 10W includes a first region W1 in contact with the first layer 1C, and a second region W2 that is continuous with the first region W1 at a connection point R1 and in contact with the second layer 2C. Accordingly, a crack propagating inward from a position between the first layer 1C and the second layer 2C (i.e., away from the internal space 3a) can be stopped at the connection point R1.

As shown in FIG. 5, the embossed portion 31 includes a contact region 31W that is in contact with the third adhering portion 43. It is preferable that the contact region 31W includes a third region W3 in contact with the third layer 3C, and a fourth region W4 that is continuous with the third region W3 at a connection point R2 and in contact with the second layer 2C. Accordingly, a crack propagating inward from a position between the second layer 2C and the third layer 3C can be stopped at the connection point R2.

Furthermore, it is preferable that, as shown in FIG. 5, the number of layers constituting the portion of the third adhering portion 43 exposed at the opening 80b of the bottomed recess 80 is greater than the number of layers constituting the portion of the third adhering portion 43 disposed in the deepest portion 80a of the bottomed recess 80. As a result, the number of layer interfaces is smaller on the deepest portion 80a side than on the opening 80b side. Therefore, it is possible to suppress the case where a crack attempting to propagate inward along a layer interface reaches the deepest portion 80a. Note that in the present embodiment, the number of layers constituting the portion of the third adhering portion 43 exposed at the opening 80b is “3”, and the number of layers constituting the portion of the third adhering portion 43 disposed in the deepest portion 80a is “1”.

The third adhering portion 43 can be formed by applying a paste containing Cr oxide to the surface of at least either the metal support 10 or the embossed portion 31, and then performing a heat treatment while the metal support 10 and the embossed portion 31 are held in close contact with each other. The heat treatment conditions can be appropriately set, for example, at 800° C. or higher and 1100° C. or lower, and for 0.5 hours or more and 24 hours or less. Note that the third adhering portion 43 may be formed at the same time as the first and second adhering portions 41 and 42.

### (Variations)

Although embodiments of the present invention have been described above, the present invention is not limited to these embodiments, and various modifications can be made without departing from the spirit of the present invention.

### [Variation 1]

In the first and second embodiments, the frame 20 and the interconnector 30 are separate members, but the frame 20 and the interconnector 30 may be an integrated member. In this case, the chromium alloy container 3 does not include the second sealing portion 50.

### [Variation 2]

In the first and second embodiments, the metal support 10 and the frame 20 are separate members, but the metal support 10 and the frame 20 may be an integrated member. In this case, the chromium alloy container 3 does not include the first sealing portion 40.

### [Variation 3]

In the first and second embodiments described above, the first adhering portion 41 is constituted by the first layer 1A, the second layer 2A, and the third layer 3A, but there is no limitation to this. The first adhering portion 41 may have a single-layer structure, or may have a multi-layer structure including two layers or four or more layers. When the first adhering portion 41 has a multi-layer structure, it is sufficient that at least one layer is constituted by Cr oxide.

### [Variation 4]

In the first and second embodiments, the second adhering portion 42 is constituted by the first layer 1B, the second layer 2B, and the third layer 3B, but there is no limitation to this. The second adhering portion 42 may have a single-layer structure, or a multi-layer structure including two layers or four or more layers. When the second adhering portion 42 has a multi-layer structure, it is sufficient that at least one layer is constituted by Cr oxide.

### [Variation 5]

In the second embodiment, the third adhering portion 43 is constituted by the first layer 1C, the second layer 2C, and the third layer 3C, but there is no limitation to this. The third adhering portion 43 may have a single-layer structure, or a multi-layer structure including two layers or four or more layers. When the third adhering portion 43 has a multi-layer structure, it is sufficient that at least one layer is constituted by Cr oxide.

### [Variation 6]

In the first and second embodiments, the first sealing portion 40 includes the first adhering portion 41 and the second adhering portion 42, but may include only either the first adhering portion 41 or the second adhering portion 42.

Also, the second sealing portion 50 has the same configuration as the first sealing portion 40, but may have a different configuration from the first sealing portion 40. The second sealing portion 50 may have only either the first adhering portion 41 or the second adhering portion 42.

### [Variation 7]

In the first and second embodiments, the metal support 10 and the frame 20 are in close contact with or integrated with each other between the first adhering portion 41 and the second adhering portion 42, but there is no limitation to this. The metal support 10 and the frame 20 do not need to be in close contact with each other or integrated with each other.

### [Variation 8]

In the above embodiments, an electrolysis cell has been described as an example of an electrochemical cell, but the electrochemical cell is not limited to an electrolysis cell. An electrochemical cell is a general term for an element in which a pair of electrodes are arranged so that electromotive force is produced from an overall oxidation-reduction reaction in order to convert electrical energy into chemical energy, and for an element for converting chemical energy into electrical energy. Thus, electrochemical cells include, for example, fuel cells that use oxide ions or protons as carriers.

### [Variation 9]

In the above embodiments, the chromium alloy container according to the present invention is applied to an electrochemical cell, but the chromium alloy container can be used for various purposes. The chromium alloy container can be applied to, for example, a methanation reactor for synthesizing methane from hydrogen and carbon dioxide.

### WORKING EXAMPLES

Working examples of the chromium alloy container according to the present invention will be described below. However, the present invention is not limited to the working examples described below.

### Samples No. 1 to 7

Chromium alloy containers according to Samples No. 1 to 7 were manufactured as follows.

First, for each sample, a paste containing at least either Cr₂O₃ or Mn₃O₄ was applied to the outer peripheral portion of the second main surface 13 of the metal support 10, and then the frame 20 was placed on the paste to produce a laminate. At this time, the Cr content among the metal elements in the Cr oxide constituting the bonded joint was varied as shown in Table 1 by changing the added amounts of Cr₂O₃ and Mn₃O₄.

Next, the laminate was subjected to a heat treatment (1000° C., 1 hour) such that an adhering portion constituted by Cr oxide and adhering the metal support 10 and the frame 20 to each other was formed from the paste. As a result, the chromium alloy container having the single-layer adhering portion was obtained. Note that in these working examples, the metal support 10 and the frame 20 were not welded or brazed.

Next, the composition of the Cr oxide constituting the adhering portion was analyzed using an EDS device to measure the Cr content among the metal elements in the Cr oxide. The Cr content at this time is shown in Table 1 as “Cr content before heat endurance test”.

Next, a heat endurance test was carried out by subjecting the chromium alloy container to a heat treatment (800° C., 1000 hours).

Next, the composition of the Cr oxide constituting the adhering portion was analyzed using an EDS device, and the Cr content among the metal elements in the Cr oxide was measured again. The Cr content at this time is shown in Table 1 as “Cr content after heat endurance test”.

TABLE 1

| | Cr concentration | Cr concentration | |
|---|---|---|---|
| | before heat | after heat | Change in Cr |
| Sample | treatment | treatment | concentration |
| No. | (mol %) | (mol %) | (mol %) |
| 1 | 30.0 | 33.0 | 3.0 |
| 2 | 40.0 | 42.0 | 2.0 |
| 3 | 50.0 | 50.2 | 0.2 |
| 4 | 60.0 | 60.2 | 0.2 |
| 5 | 80.0 | 80.1 | 0.1 |
| 6 | 100.0 | 100.0 | 0.0 |
| 7 | <0.1 | 18.0 | 17.9-18.0 |

As shown in Table 1, in Samples No. 3 to 6, in which the Cr content among the metal elements in the Cr oxide constituting the adhering portion was set to 50 mol % or more, the change in Cr content before and after the heat endurance test was significantly reduced. Based on this, it was found that by setting the Cr content among the metal elements in the Cr oxide constituting the adhering portion to 50 mol % or more, it is possible to significantly suppress the diffusion of Cr contained in the metal support 10 and the frame 20 to the adhering portion.

### Samples No. 8 to 14

Chromium alloy containers 3 (see FIG. 3) according to Samples No. 8 to 14 were manufactured as follows.

First, for each sample, a paste containing Cr₂O₃, a paste containing MnCr₂O₄, and a paste containing Cr₂O₃ were successively applied to the outer peripheral portion of the second main surface 13 of the metal support 10, and then the frame 20 was placed on the pastes to produce a laminate. At this time, as shown in Table 2, the thickness ratios of the first to third layers 1A to 3A and the first to third layers 1B to 3B was changed by changing the applied amounts of the pastes.

Next, the metal support 10 and the frame 20 were lap-welded to integrate the metal support 10 and the frame 20 with each other between the first adhering portion 41 and the second adhering portion 42.

Next, the laminate was subjected to a heat treatment (1000° C., 1 hour) such that the first and second adhering portions 41 and 42 constituted by Cr oxide and adhering the metal support 10 and the frame 20 to each other were formed from the pastes. As a result, the chromium alloy container 3 having the first and second adhering portions 41 and 42 each having a three-layer structure was obtained.

Next, a heat endurance test was carried out by subjecting the chromium alloy container 3 to a heat treatment (800° C., 1000 hours).

Next, the chromium alloy container 3 was cut along the thickness direction to expose a cross section of the first adhering portion 41 along the thickness direction.

Next, using the method described in the above embodiments, the thicknesses of the first to third layers 1A to 3A were measured in the cross section of the first adhering portion 41, and the thickness ratio of the thickest layer to the thinnest layer was calculated based on the measured thicknesses. The calculated thickness ratios are shown in Table 2.

Next, the cross section of the first adhering portion 41 was observed with an SEM to check for the presence or absence of a crack inside the first adhering portion 41. The crack results are shown in Table 2.

TABLE 2

| Sample | Thickness ratio of thickest | |
|---|---|---|
| No. | layer to thinnest layer | Crack |
| 8 | 1.1 | No |
| 9 | 2.0 | No |
| 10 | 3.0 | No |
| 11 | 4.0 | No |
| 12 | 5.0 | No |
| 13 | 6.0 | Yes |
| 14 | 7.0 | Yes |

As shown in Table 2, in Samples No. 8 to 12 in which the thickness ratio of the thickest layer to the thinnest layer among the first to third layers 1A to 3A was 5 or less, no cracks were formed even after the heat endurance test. Based on this, it was found that the mechanical reliability of the first adhering portion 41 can be improved by setting the thickness ratio of the thickest layer to the thinnest layer among the first to third layers 1A to 3A to 5 or less.

Although not shown in Table 2, results the same as those for the first adhering portion 41 were obtained for the second adhering portion 42.

### REFERENCE SIGNS LIST

1, 1a Electrolysis cell
2 Cell body portion
3 Chromium alloy container
3a Internal space
6 Hydrogen electrode
7 Electrolyte
8 Reaction prevention layer
9 Oxygen electrode
10 Metal support
11 Supply hole
12 First main surface
13 Second main surface
20 Frame
30 Interconnector
31 Embossed portion
40 First sealing portion
41 First adhering portion
42 Second adhering portion
43 Third adhering portion
1A, 1B, 1C First layer
2A, 2B, 2C Second layer
3A, 3B, 3C Third layer
50 Second sealing portion

1. A chromium alloy container comprising:
a first alloy member constituted by an alloy containing chromium;
a second alloy member constituted by an alloy containing chromium; and
an adhering portion adhering the first alloy member and the second alloy member to each other, wherein
the adhering portion is constituted by an oxide containing chromium as a main component.

2. The chromium alloy container according to claim 1, wherein
a chromium content among metal elements in the oxide is 50 mol % or more.

3. The chromium alloy container according to claim 1, wherein
the oxide is constituted by at least either chromium oxide or chromium manganese oxide.

4. The chromium alloy container according to claim 1, wherein
the oxide is crystalline.

5. The chromium alloy container according to claim 4, wherein
the oxide has a spinel type crystal structure or a corundum type crystal structure.

6. The chromium alloy container according to claim 1, wherein
the adhering portion includes a first layer disposed on the first alloy member, and a second layer disposed between the first layer and the second alloy member, and
an oxide constituting the second layer is different from an oxide constituting the first layer.

7. The chromium alloy container according to claim 6, wherein
the adhering portion further includes a third layer sandwiched between the second layer and the second alloy member, and
an oxide constituting the third layer corresponds to the oxide constituting the first layer.

8. The chromium alloy container according to claim 7, wherein
a thickness ratio of a thickest layer to a thinnest layer among the first layer, the second layer and the third layer is 5 or less.

9. The chromium alloy container according to claim 6, wherein
a surface of the first alloy member includes a contact region in contact with the adhering portion, the contact region including a first region in contact with the first layer and a second region in contact with the second layer, and
the second region is continuous with the first region.

10. The chromium alloy container according to claim 9, wherein
the adhering portion is embedded in a bottomed recess formed between the first alloy member and the second alloy member, and
a number of layers constituting a portion of the adhering portion exposed at an opening of the bottomed recess is greater than the number of layers constituting a portion of the adhering portion disposed in a deepest portion of the bottomed recess.

11. The chromium alloy container according to claim 1, wherein
the adhering portion is a seal for sealing the internal space.

12. The chromium alloy container according to claim 1, wherein
the second alloy member has an embossed portion in contact with the first alloy member, and
the adhering portion adheres the embossed portion to the first alloy member.

13. A metal-supported electrochemical cell comprising:
the chromium alloy container according to claim 1; and
a cell body portion disposed on the chromium alloy container, wherein
the first alloy member has a plurality of communication holes in communication with the internal space, and
the cell body portion is disposed on the first alloy member in such a manner as to cover the plurality of communication holes.
